(19) United States
(12) Patent Application Publication
(10) Pub. No.: US 2003/0103663 A1
(43) Pub. Date: Jun. 5, 2003

(54) Computerized scheme for distinguishing between benign and malignant nodules in thoracic computed tomography scans by use of similar images

(75) Inventors: Qiang Li, Clarendon Hills, IL (US); Kunio Doi, Willowbrook, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: University of Chicago, Chicago, IL (US)

(21) Appl. No.: 09/990,377

(22) Filed: Nov. 23, 2001

(51) Int. Cl. G06K 9/00

(52) U.S. Cl. 382/131

(57) ABSTRACT

A computerized scheme to assist radiologists in improving the diagnostic accuracy for abnormalities (e.g., nodules) in medical images by use of similar images for malignant abnormalities and benign abnormalities. The method includes developing a database of medical images which includes both confirmed cancers and confirmed benign abnormalities; obtaining a medical image including at least one abnormality; selecting at least one feature for comparison from an unknown abnormality and at least one known abnormality, respectively; determining a similarity measure between an unknown, undiagnosed abnormality and at least one of the previously diagnosed abnormalities; and selecting from the database of known abnormalities at least one known abnormality for comparison with the unknown abnormality in order to determine a likelihood of malignancy. In one embodiment, an artificial neural network is employed to determine a similarity measure between an unknown nodule and at least one known nodule.

The present invention was made in part with United States Government support under grant number CA62625 and CA64370 from the USPHS. The United States Government may have certain rights to this invention.

### BACKGROUND OF THE INVENTION

1. Field of the Invention

The invention relates generally to the computerized, automated assessment of medical images, (e.g., computed tomography (CT) scans (or images)), and more particularly to methods, systems, and computer program products for distinguishing between benign and malignant abnormalities on thoracic CT scans.

The present invention also generally relates to computerized techniques for automated analysis of digital images, for example, as disclosed in one or more of U.S. Pat. Nos. 4,839,807; 4,841,555; 4,851,984; 4,875,165; 4,907,156; 4,918,534; 5,072,384; 5,133,020; 5,150,292; 5,224,177; 5,289,374; 5,319,549; 5,343,390; 5,359,513; 5,452,367; 5,463,548; 5,491,627; 5,537,485; 5,598,481; 5,622,171; 5,638,458; 5,657,362; 5,666,434; 5,673,332; 5,668,888; 5,732,697; 5,740,268; 5,790,690; 5,832,103; 5,873,824; 5,881,124; 5,931,780; 5,974,165; 5,982,915; 5,984,870; 5,987,345; 6,011,862; 6,058,322; 6,067,373; 6,075,878; 6,078,680; 6,088,473; 6,112,112; 6,138,045; 6,141,437; 6,185,320; 6,205,348; 6,240,201; 6,282,305; 6,282,307; 6,317,617 as well as U.S. patent application Ser. Nos. 08/173,935; 08/398,307 (PCT Publication WO 96/27846); 08/536,149; 08/900,189; 09/027,468; 09/141,535; 09/471,088; 09/692,218; 09/716,335; 09/759,333; 09/760,854; 09/773,636; 09/816,217; 09/830,562; 09/818,831; 09/842,860; 09/860,574; 60/160,790; 60/176,304; and 60/329,322; co-pending applications (listed by attorney docket number) 215807US-730-730-20; 215808US-730-730-20; 216439US-730-730-20 PROV; and 216504US-730-730-20 PROV; and PCT patent applications PCT/US98/15165; PCT/US98/24933; PCT/US99/03287; PCT/US00/41299; PCT/US01/00680; PCT/US01/01478 and PCT/US01/01479, all of which are incorporated herein by reference.

The present invention includes use of various technologies referenced and described in the above-noted United States Patents and Applications, as well as described in the references identified in the following list of references by the author(s) and year of publication and cross referenced throughout the specification by reference to the respective number, in parentheses, of the reference:

### List of References

1. Sone, S. et al., Mass Screening for Lung Cancer with Mobile Spiral Computed Tomography Scanner, Lancet 1998, 351(9111):242-245.

2. Takizawa, M. et al., The Mobile Hospital—An Experimental Telemedicine System for the Early Detection of Disease, Journal of Telemedicine and Telecare, 1998, at 146-151.

3. Sone, S. et al., Characteristics of Small Lung Cancers Invisible on Conventional Chest Radiography: Analysis of 44 Lung Cancers Detected by Population-Based Screening Programme for Lung Cancer Using Mobile Low-Dose Spiral CT, The British Journal of Radiology, 2000, 73:137-145.

4. Sone, S. et al., Results of Three-Year Mass Screening Programme for Lung Cancer Using Mobile Low-Dose Spiral Computed Tomography Scanner, British Journal of Cancer 2001, 84:25-32.

5. Giger, M. L. et al., Image Feature Analysis and Computer-Aided Diagnosis in Digital Radiography, Med. Phys. 1988, 15:158-166.

6. Giger, M. L. et al., Pulmonary Abnormalities: Computer-Aided Detection in Digital Chest Images, Radiographics 1990, 10:41-51.

7. Xu, X. et al., Development of an Improved CAD Scheme for Automated Detection of Lung Abnormalities in Digital Chest Images, Med. Phys. 1997, 24:1395-1403.

8. Armato, S. G., et al., Computerized Detection of Pulmonary Abnormalities on CT Scans, RadioGraphics 1999, 19:1303-1311.

9. Armato, S. G., et al., Automated Lung Segmentation in Digitized Posteroanterio Chest Radiographs, Acad. Radiol. 1998, 5:245-255.

10. Amini, A. A., et al., Using Dynamic Programming for Solving Variational Problem in Vision, IEEE Trans. on Patt. Recog. and Mach. Intell. 1990, 12:855-867.

11. Yamada, et al., Recognition of Kidney Glomerulus By Dynamic Programming Matching Method, IEEE Trans. Pattern Anal. Machine Intell. 1988, 10:731-737.

12. Metz, C. E., ROC Methodology in Radiologic Imaging, Invest. Radiol. 1986, 21:720-733.

13. Metz, C. E., Some Practical Issues of Experimental Design and Data Analysis in Radiological ROC Studies, Invest. Radiol. 1989, 24:234-245.

14. Nakamura, K. et al., Computerized Analysis of the Likelihood of Malignancy in Solitary Pulmonary Abnormalities with Use of Artificial Neural Networks, Radiology 2000, 214:823-830.

15. Huo, Z., et al., Analysis of Spiculation in the Computerized Classification of Mammographic Masses, Med. Phys. 1995,22:1569-1579.

16. Press, W. H. et al., Numerical Recipes: The Art of Scientific Computing, Cambridge University Press 1986, at 498-546.

17. Jain, A. K., Fundamentals of Digital Image Processing, Prentice-Hall 1989, at 400-402.

18. Ashizawa, K. et al., Artificial Neural Networks in Chest Radiography: Application to the Differential Diagnosis of Interstitial Lung Diseases, Acad. Radiol. 1999, 6:2-9.

19. Huo, Z. et al., Effect of Dominant Features on Neural Network Performance in the Classification of Mammographic Lesions, Phys. Med. Biol. 1999, 44:2579, 2595.

The contents of each of these references are incorporated herein by reference. The techniques disclosed in the patents and references can be utilized as part of the present invention.

2. Discussion of the Background

It is well known that distinguishing between malignant and benign lung abnormalities (e.g., nodules) in computed tomography (CT) scans is a difficult tasks for radiologists, particularly in the screening for early detection of lung cancer using low-dose CT (LDCT). However, presenting abnormalities visually similar to an unknown abnormality would be useful in assisting radiologists in the diagnosis of the unknown abnormality.

A fundamental issue for the selection of “good” similar abnormalities to an unknown abnormality is the determination of a “good” objective similarity measure, which should correlate well with the subjective similarity rating assessed by radiologists. Previously, it was difficult to determine such a good objective similarity measure because it was unclear how radiologists subjectively perceive and/or determine a similarity rating. Consequently, there are no standard methods for defining a good objective similarity measure or for selecting good similar abnormalities from a database of previously diagnosed, known abnormalities.

### SUMMARY OF THE INVENTION

Accordingly, an object of this invention is to provide a method, system, and computer program product for the automated determination of the most similar abnormalities of known diagnosis for comparison with an abnormality of unknown diagnosis, including using an artificial neural network to determine the most similar abnormalities of known diagnosis for comparison with the unknown candidate abnormality.

This and other objects are achieved by way of a method, system, and computer program product constructed according to the present invention, wherein a likelihood of malignancy of a candidate abnormality is assessed in a medical image. One such environment is thoracic CT scans acquired using a low-dose CT scan.

In particular, according to one aspect of the present invention, there is provided a novel method for assessing a likelihood of malignancy of an unknown abnormality, including the steps of obtaining an image including a thoracic image with at least one candidate abnormality, segmenting the abnormality in the obtained image, extracting at least one feature from at least one candidate abnormality, and comparing the extracted features of the unknown abnormality with the same extracted features from previously diagnosed, known abnormalities.

According to other aspects of the present invention, there are provided a novel system implementing the method of this invention and a novel computer program product, which upon execution causes the computer system to perform the above method of the invention.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a block diagram for the determination of a similarity measure between a candidate abnormality and a known abnormality by use of features;

FIG. 2 is a graph illustrating average receiver operating characteristics (ROC) curves with and without the aid of similar known abnormalities;

FIG. 3 is a graph illustrating the distribution of average similarity ratings between radiologists and physicists;

FIG. 4 is a graph illustrating a distribution of subjective similarity ratings and computed similarity measures using effective diameter;

FIG. 5 is a graph illustrating a distribution of subjective similarity ratings and computed similarity measures using effective diameter and CT value;

FIG. 6 is a graph illustrating a distribution of subjective similarity ratings and computed similarity measures using effective diameter, CT value, and RGI;

FIG. 7 is a graph illustrating a distribution of subjective similarity ratings and converted computed similarity measures using effective diameter, CT value, and RGI;

FIG. 8 is a graph illustrating a distribution of subjective similarity ratings and computed similarity measures using the pixel-value-difference technique;

FIG. 9 is a graph illustrating a distribution of subjective similarity ratings and computed similarity measures using the cross correlation technique;

FIG. 10 is a graph illustrating a distribution of subjective similarity ratings and computed similarity measures using the artificial neural network technique;

FIG. 11 is a graph illustrating the relationship between the number of hidden units and the performance of artificial neural networks; and

FIG. 12 is an illustration of an example for the diagnosis of a candidate abnormality with the aid of similar database abnormalities for three benign abnormalities and three malignant abnormalities.

### DETAILED DESCRIPTION OF THE PREFERRED EMBODIMENTS

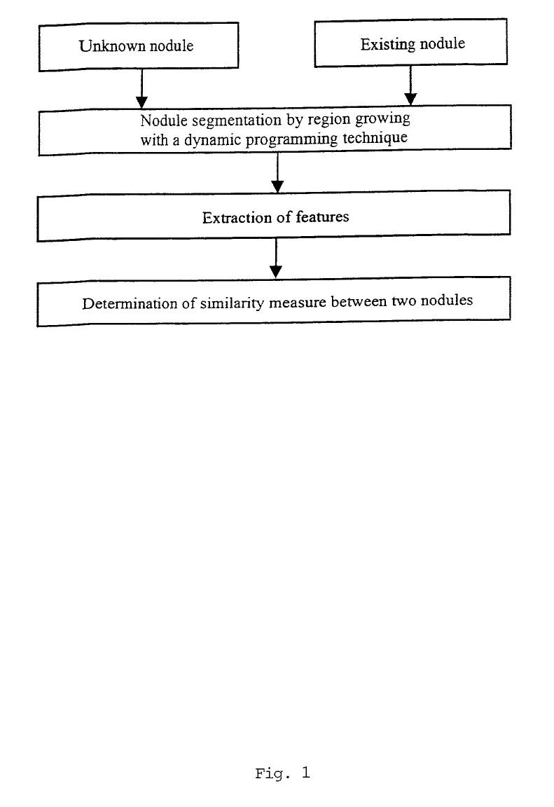

Referring now to the drawings, wherein like reference numerals designate identical or corresponding parts throughout the several views, FIG. 1 discloses a method of determining a similarity measure between a candidate abnormality and a known abnormality. As described herein, the inventors discovered that an artificial neural network provides a similarity measure which closely correlates to a subjective similarity rating. From May 1996 to March 1999, 17,892 examinations on 7,847 individuals (with average age of 66 years) were performed as part of an annual low-dose helical CT (LDCT) screening program for early detection of lung cancers. There were 7,847 initial examinations performed the first year, and 5,025 and 5,020 repeat examinations performed in the following two years. During these examinations, 605 patients were found with 747 suspicious pulmonary abnormalities. Of these 605 patients with suspicious pulmonary abnormalities, 73 patients were confirmed with 76 primary lung cancers by surgery or biopsy, and 342 patients were confirmed with 413 benign abnormalities by diagnostic CT, two-year follow-up examinations, or surgery. The other patients were suspected to have either malignant or benign abnormalities. The database employed in this study was created using ROIs from the 73 LDCT scans with 76 confirmed malignant abnormalities and the 342 LDCT scans with 413 benign abnormalities.

A mobile unit equipped with a CT scanner was used for scanning the chest with a 10 mm collimation and a 10 mm reconstruction interval (section thickness). Each section was saved in the DICOM image format, with a matrix size of 512×512, a pixel size of 0.586 mm, and 4096 (12 bits) gray levels in Hounsfield units (Hus). The size ranged from 6 mm to 30 mm (average of 14 mm) for malignant abnormalities, and from 3 mm to 30 mm (average of 8 mm) for benign abnormalities. The location of abnormalities was identified by a chest radiologist based on LDCT findings for each of the 489 abnormalities (76 malignant and 413 benign), and a region of interest (ROT) of 42×42 mm² (72×72 pixels) was then obtained at the center of an abnormality. When an abnormality was recognized in multiple sections, only one ROT from the section in which the abnormality had the largest area was used. The ROIs with the 489 abnormalities constituted the database used in this study.

Initially, to verify whether similar images for malignant and benign abnormalities can assist radiologists in improving their performance in the diagnosis of an unknown abnormality in CT scans, five (5) radiologists participated in an observer study in which they rated the likelihood of malignancy for the unknown abnormality without and with the similar abnormalities. A feature based technique was used to search for similar malignant and benign abnormalities with respect to the unknown abnormality to be diagnosed. From the set of 489 abnormalities, 36 abnormalities were randomly selected as unknown abnormalities. One half (18) of the abnormalities were malignant, and the other half (18) were benign. For each of the unknown abnormalities, the three most similar malignant abnormalities and the three most similar benign abnormalities were selected from the remaining database abnormalities. None of the radiologists participating in the study had previously viewed any of the abnormalities used in this study. For each of the unknown abnormalities, a participating radiologist first rated the likelihood of malignancy based on the observation of the unknown abnormality only by marking his/her level of confidence on a line with a continuous rating scale, where the right and left ends of the scale represented definite malignancy and definite benignancy, respectively. Then, the three most similar malignant abnormalities and the three most similar benign abnormalities were presented adjacent to the unknown abnormality and were shown to the radiologists. The radiologist was requested to re-rate the likelihood of malignancy for the unknown abnormality after having observed the similar abnormalities. The observer could maintain his/her initial rating if the similar abnormalities did not provide any new information for his/her judgment. Therefore, for each of the unknown abnormalities, there were two ratings for the likelihood of malignancy, with and without the aid of similar abnormalities, respectively. There was no time limit for the radiologists to make their decisions.

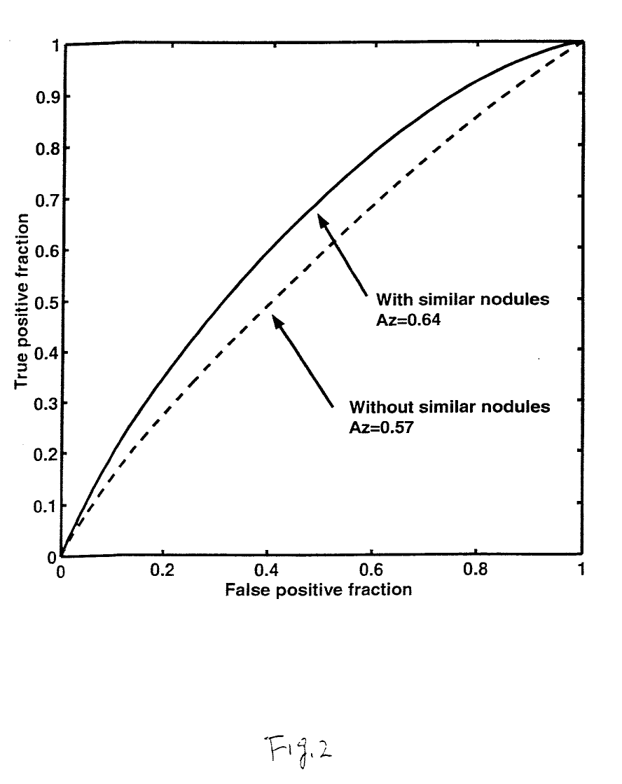

The performance of the five radiologists with and without the aid of similar abnormalities was evaluated by use of receiver operating characteristic (ROC) analysis. (See References 12 and 13). FIG. 2 shows the average ROC curves for the five radiologists in the diagnosis of lung abnormalities with and without the aid of similar abnormalities. The Az value, the area under the ROC curve, for the average performance of the five radiologists was increased from 0.57 to 0.64 with the aid of similar abnormalities (P<0.003). In fact, all radiologists improved their performance with the aid of similar abnormalities, and the increase in Az values ranged from 0.05 to 0.12. Therefore, it is believed that the radiologists' performance in the diagnosis of lung abnormalities in CT images can be improved significantly with the aid of similar abnormalities. It should be noted that the Az values in this observer study were quite low because the diagnosis of lung abnormalities in LDCT images is very difficult.

In order to gain insight into the visual perception of similar images by human observers to further improve the design of the artificial neural network, a second study was performed in which twenty (20) candidate abnormalities were randomly selected from the set of 489 abnormalities. Of these twenty candidates, eleven (11) were malignant and nine (9) were benign. Six (6) similar malignant and six (6) similar benign abnormalities were then selected based upon the above-described technique. Therefore, a total of 240 (20×12) pairs of abnormalities were used in this observer study. For this observer study, ten (10) radiologists and ten (10) physicists participated. The goal of this study was to determine the reliability of subjective similarity and to determine how to use subjective similarity ratings to improve the performance of the artificial neural network. Each of the participants rated independently the similarity based on the overall impression for each of the 240 pairs of abnormalities with the following rating scores:

0: the two abnormalities are not similar,

1: the two abnormalities are somewhat similar,

2: the two abnormalities are very similar, and

3: the two abnormalities are almost identical.

The observers were allowed to use a fractional number, such as 1.1, 1.2, or 1.3 to express a similarity rating. There was no time limit for this observer study.

This study disclosed that there is a large variation between the subjective similarity ratings assessed by two radiologists. The average correlation coefficient for all pairs of two radiologists among the ten radiologists was only 0.47. Therefore, it is believed that the subjective similarity rating is a very difficult task for radiologists, and that it is difficult to obtain reliable subjective similarity ratings from a single radiologist.

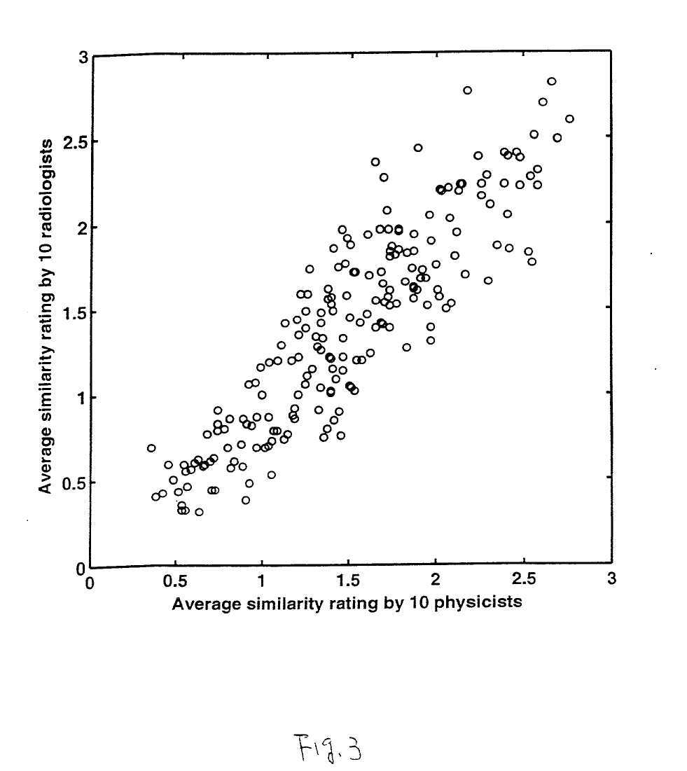

However, it is believed that the average subjective similarity ratings assessed by a group of observers is more reliable than that assessed by a single observer. FIG. 3 illustrates the distribution of the average subjective similarity ratings assessed by ten radiologists and ten physicists who participated in our observer study. It is apparent that the average subjective similarity ratings assessed by ten radiologists correlate well with those assessed by physicists. The correlation coefficient between the two average similarity ratings was greater than 0.88, which is a remarkably high value compared with that between two radiologists. Therefore, a “gold standard” equal to the average subjective similarity ratings assessed by the ten radiologists was employed in the computerized determination scheme.

Computerized Schemes for the Determination of Similarity Measures

FIG. 1 is a block diagram of a method for the determination of a similarity measure between a candidate abnormality and an existing abnormality by use of selected features. The overall scheme includes an initial acquisition of CT image data in steps S10 and S12. For each image, the candidate abnormality is segmented using an automated or semi-automated process.

For the automated process, the candidate abnormality is segmented using a region growing (RG) technique and a dynamic programming (DP) technique. (See references 5-11).

For the semi-automated process, the abnormality is segmented using a manual outline of the abnormality.

Next, selected features are extracted from the candidate abnormality in S16. Features are also selected from a known abnormality in S16. A similarity measure is then determined from a comparison of the selected features of the candidate abnormality with the selected features of respective database abnormalities in S18.

FIG. 1 illustrates that the existing nodule (known abnormality) may be processed simultaneously with the unknown nodule (candidate abnormality). Preferably, the processing of the known abnormalities is performed prior to the processing of the candidate abnormalities and information regarding the extracted features is stored in a database. Such a system enables reduced computation time during the analysis of the candidate abnormalities.

For the above observer study, the features analyzed were effective diameter, degree of circularity, and the contrast. For the above observer study, the similarity measure is defined as the distance between two abnormalities in three dimensional (3D) feature space by the formula:

d²(f,g)=(|f(1)−g(1)|²+|f(2)−g(2)|²+|f(3)−g(3)|²)/3 (1)

where f={f(1), f(2), f(3)} and g={g(1), g(2), g(3)} are the 3D feature vectors representing the two nodules, respectively, and d(f,g) is the similarity measure between the two nodules. The smaller this similarity measure, the more similar the two abnormalities are likely to be.

Because an ROI may contain the background regions that are located outside the region of tissue to be analyzed (e.g. outside the lung region, such as the chest wall), it is necessary to determine a mask ROI for lung regions, in which a value of “1” or “0” represents a pixel inside or outside the tissue of interest regions, respectively. A mask ROI has the same matrix size (approximately 42×42 mm) as an original ROI. Based on an original ROI and its corresponding mask ROI, a region growing technique and a dynamic programming technique were then applied to the lung regions of the original ROI for the segmentation of an abnormality. (See References 5-11). Although the automated technique for abnormality segmentation was employed for determining the features and similarity measures in the early stage of this study, more accurate results for the determination of similarity measures were obtained by use of the abnormality outlines when the abnormalities were manually delineated by radiologists. This is important because even relatively small errors in abnormality segmentation can greatly affect the accuracy of features and thus the similarity measures. Except when otherwise specified, when referring to abnormality outlines hereafter, it is assumed that the outlines of the abnormalities were manually delineated by a radiologist. In addition to the abnormality region in the ROI, a ring-shaped background region immediately adjacent to the abnormality region, having a width of 5 mm, was also automatically determined. This abnormality background region was used to calculate some features, such as contrast.

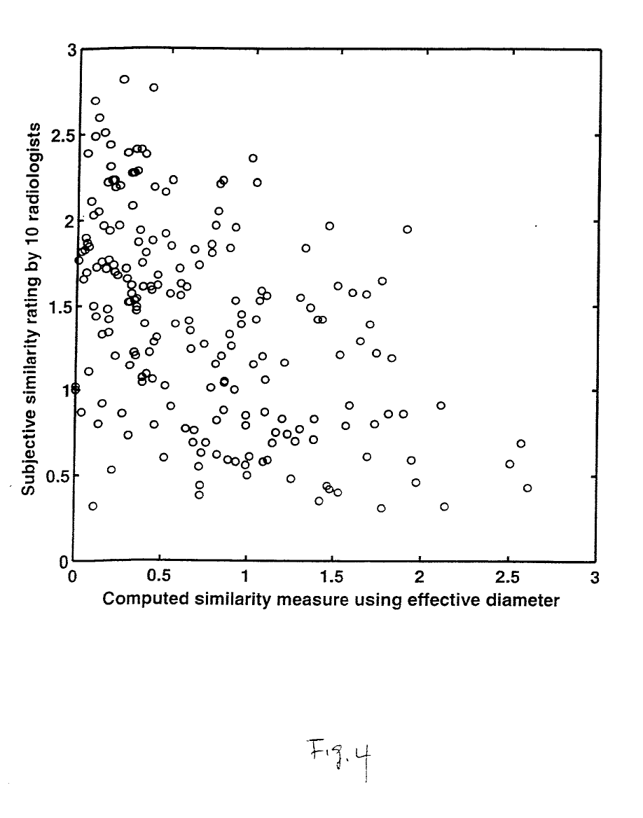

Table 1 shows the definition and the significance of the seven features (effective diameter, degree of circularity, degree of irregularity, CT value, contrast, pixel standard deviation, and radial gradient index (RGI)) employed for the determination of similarity measures. These features were selected because they were considered to be important to radiologists in their distinction between malignant and benign abnormalities. (References 14 and 15). In order to determine the importance of individual features, a similarity measure was defined as the absolute difference in a single feature between a pair of abnormalities. FIG. 4 shows the distribution of the computed similarity measures using the effective diameter alone plotted against the subjective similarity ratings assessed by the ten radiologists. Although there is a large variation between the computed similarity measures and the subjective similarity ratings, it is apparent that when the difference in the effective diameters between two abnormalities is large, the subjective similarity rating would be low, namely, the radiologists considered the two abnormalities to be dissimilar with a large difference in the effective diameter and vice versa. The correlation coefficient between the computed similarity measures using the effective diameter alone and the subjective similarity ratings is −0.47. The greater the absolute value of the correlation coefficient, the more correlated the computed similarity measures and the subjective similarity ratings would be, thus indicating the importance of the feature employed in the determination of the similarity measure. Table 2 lists the correlation coefficients between the subjective similarity ratings and the computed similarity measures by use of each of the seven features. It should be noted that the degree of irregularity, which is generally considered to be important and frequently employed for the distinction between malignant abnormalities and benign abnormalities, is almost irrelevant to the determination of similarity ratings by radiologists (the correlation coefficient is close to 0). Another important feature, the degree of circularity, is also not significant for the determination of similarity, although it was used for the selection of similar abnormalities in the above-described observer study. These results indicate that some features useful for the distinction between malignant and benign abnormalities are not necessarily important for the determination of a similarity measure. The data indicates that radiologists assessed the similarity between a pair of abnormalities mainly based on abnormality size (effective diameter), abnormality contrast (contrast and CT value), and pixel value variation inside an abnormality (pixel standard deviation and RGI), but not the shape of the abnormality (circularity and irregularity).

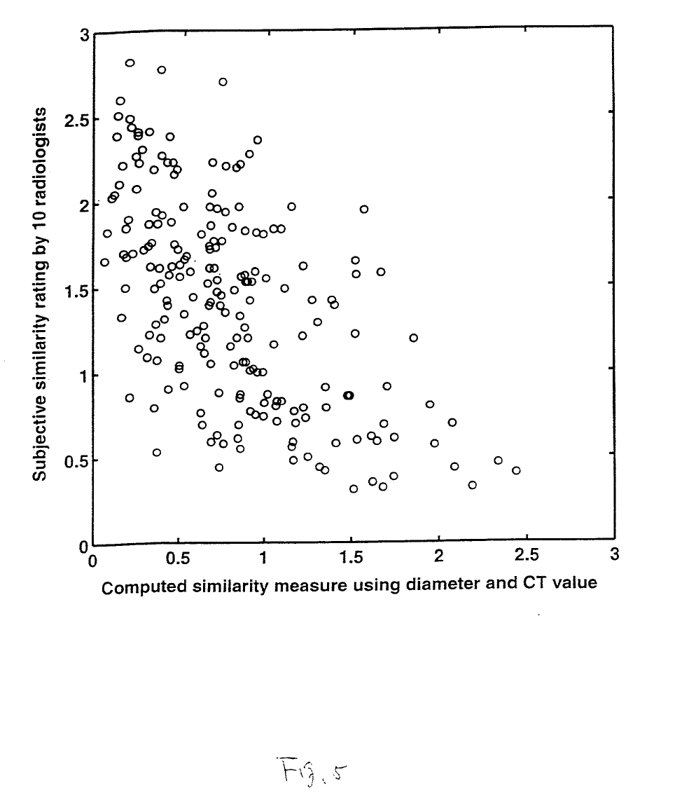

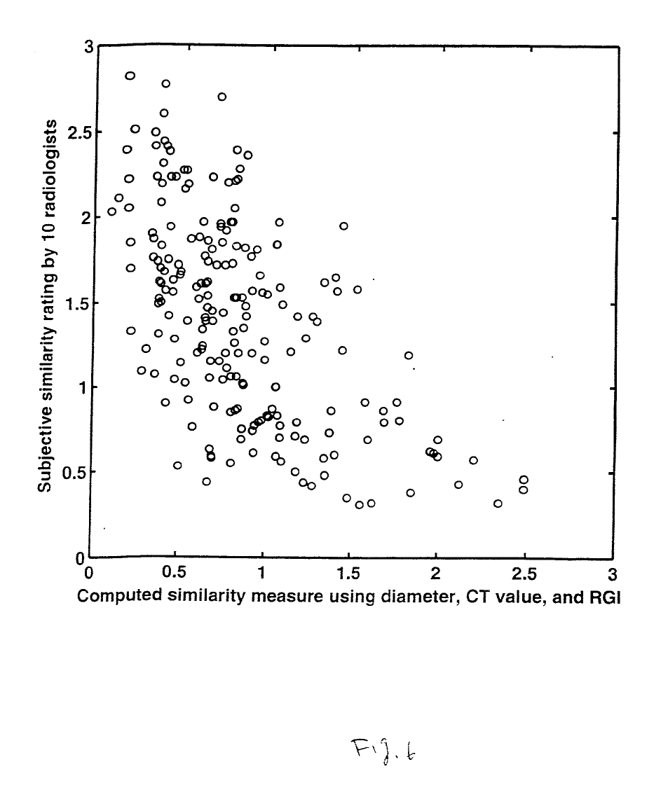

The similarity measure was then determined by use of a combination of multiple features, according to the following equation:

$${ⅆ}^{2} ( f , g ) = \frac{1}{N} ( {{\sum }^{N}}_{i = 1} {\vert f ( i ) - g ( i ) \vert}^{2} ) , \qquad ( 2 )$$

where f={f(1), f(2), . . . , f(N)} and g={g(1), g(2), . . . , g(N)} are the N-dimensional feature vectors for the two abnormalities, respectively. The similarity measure was determined by use of all combinations of two features (N=2), and it was determined that the combination of effective diameter and CT value provided a good result among all possible combinations of two features. FIG. 5 shows the distribution of the computed similarity measure using the effective diameter and CT value against the subjective similarity rating, which produced a correlation coefficient of −0.57 between the similarity measure and the similarity rating. Similarly, the combination of effective diameter, CT value, and RGI provided another good result among all possible combinations of three features, as shown in FIG. 6 (correlation coefficient of −0.59). Similarity measures based on more than three features were also determined, and it was discovered that the benefits of additional features are either negligible or decreased compared to the use of the combination of the effective diameter, CT value, and RGI. These three features most capture the important and useful information for radiologists to assess the similarity ratings; therefore, these three features were employed in the next stage of the computerized system.

A disadvantage of using the distance in the feature space (Equation 2) as a similarity measure is its reverse correlation (negative correlation coefficient) with the subjective similarity rating. To address this problem, the following exponential function was employed to provide a new similarity measure:

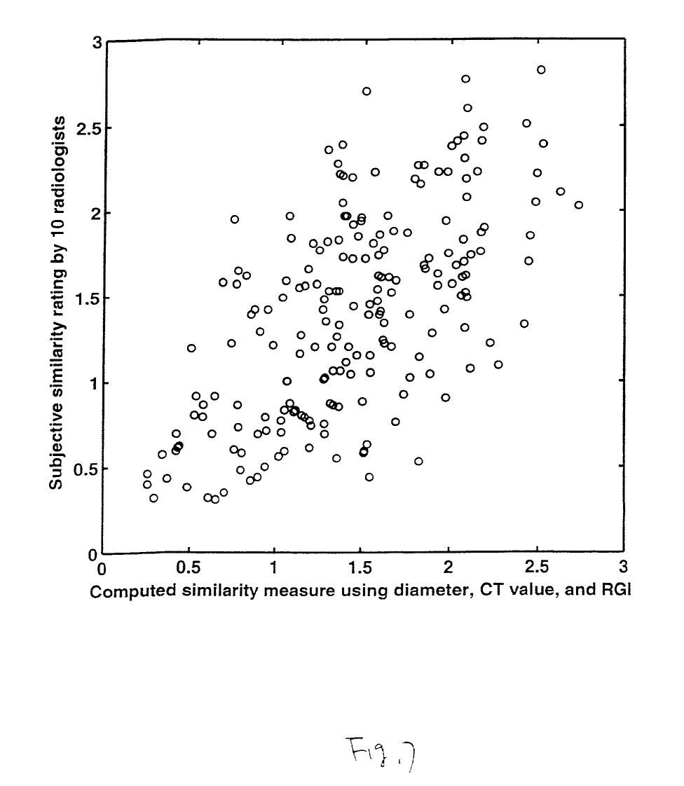

s(f,g)=3×e^{-A×d(f,g)} (3)

where s(f,g) is the new similarity measure, d(f,g) is the distance in the feature space determined by Equation 2, and A is a constant to be determined. A scaling factor of 3 was used to adjust the new measure to be in the same range as that for the subjective similarity ratings. The constant A was equal to 0.98 in this study, which was determined by fitting the above equation to the data in FIG. 6 with a least square method. (See Reference 16). FIG. 7 shows the distribution of the converted similarity measure against the subjective similarity ratings. It should be noted in FIG. 7 that the data points are distributed along the diagonal line of 45 degrees, and the correlation coefficient between the similarity measure and the similarity rating is 0.60, which has been improved slightly from −0.59.

The similarity measure defined above is based on the similarity of the features for a pair of abnormalities. The following two techniques are based on the pixel values of the two images to be compared. (See Reference 17). The pixel value difference technique defines a similarity measure by:

$${ⅆ}^{2} ( I , J ) = \frac{1}{\vert D \vert} ( {\sum }_{( m , n ) in D} {\vert I ( m , n ) - J ( m , n ) \vert}^{2} ) , \qquad ( 4 )$$

where d(I,J) is the root mean square (RMS) difference in pixel values between the two abnormalities in ROIs I and J, D is the intersection of two regions in the two ROIs, each of which includes the abnormality area and the ring-shaped background area, and |D| is the number of pixels inside the region D. Another exponential function was then employed to convert the RMS pixel difference into a similarity measure that has a positive correlation coefficient with the subjective similarity rating using the formula:

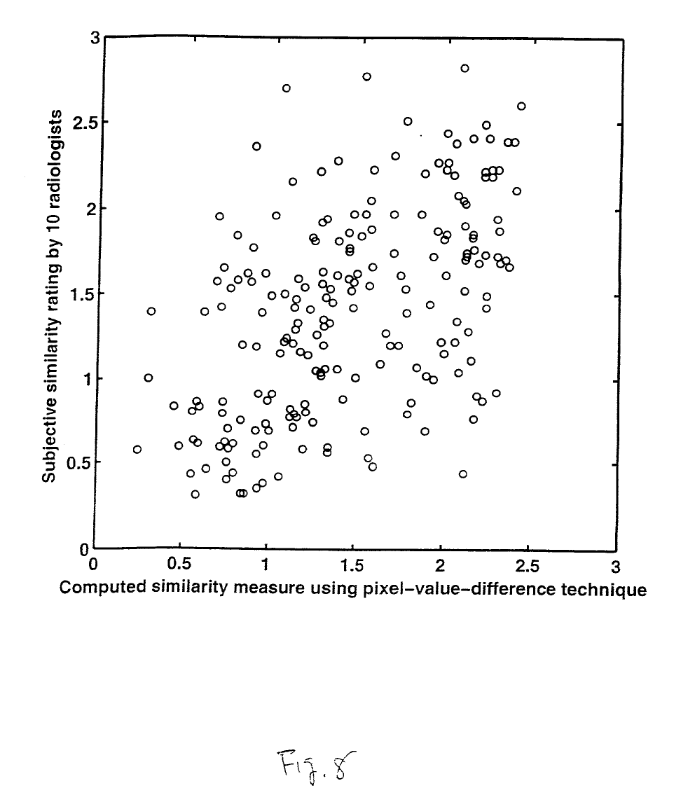

s(I,J)=3×e^{-B×d(I,J)} (5)

where s(I,J) is the similarity measure, d(I,J) is the RMS pixel difference, and B is a constant. In this study, the constant B was determined to be 0.008 by use of the least square method. (See Reference 16). FIG. 8 shows the distribution of the similarity measure based on the RMS pixel difference against the subjective similarity ratings assessed by ten radiologists. The correlation coefficient between the pixel-value-difference based similarity measure and the subjective similarity rating was 0.49, which is smaller than that between the feature-based similarity measure and the subjective similarity rating. It should also be noted that the data points in FIG. 7 are distributed closer to the diagonal line of 45 degrees than those in FIG. 8. It is apparent, therefore, that the feature-based similarity measure provided better results than the pixel-value-difference based measure.

A cross correlation technique was also employed for the determination of another similarity measure between two images to be compared. The cross correlation coefficient was defined by:

$${c}^{2} ( I , J ) = \frac{1}{\vert D \vert} ( {\sum }_{( m , n ) in D} \frac{\{ I ( m , n ) - \overline{I} \} \{ J ( m , n ) - \overline{J} \}}{{σ}_{I} {σ}_{J}} ) , \qquad ( 6 )$$

where c(I,J) is the cross-correlation coefficient between the two abnormalities in ROIs I and J, D is a region defined above, |D| is the number of pixels inside D, \overline{I} and σ_{I} are the mean and the standard deviation of the pixel values inside region D of the ROI I, respectively, and \overline{J} and σ_{J} are the mean and the standard deviation of the pixel values inside the region D of the ROI J, respectively. The mean and the standard deviation of the pixel values inside region D of the ROIs I and J are defined by the following equations:

$$\begin{matrix}\overline{I} = \frac{1}{\vert D \vert} ( {\sum }_{( m , n ) in D} I ( m , n ) ) , & ( 7 ) \\ \overline{J} = \frac{1}{\vert D \vert} ( {\sum }_{( m , n ) in D} J ( m , n ) ) , & ( 8 ) \\ {σ}_{1}^{2} = \frac{1}{\vert D \vert} ( {\sum }_{( m , n ) in D} {\vert I ( m , n ) - \overline{I} \vert}^{2} ) , & ( 9 ) \\ {σ}_{J}^{2} = \frac{1}{\vert D \vert} ( {\sum }_{( m , n ) in D} {\vert J ( m , n ) - \overline{J} \vert}^{2} ) . & ( 10 )\end{matrix}$$

Again, an exponential function was employed to convert the cross correlation coefficient to a similarity measure so that the data points would be distributed along the diagonal line of 45 degrees in the distribution graph of the similarity measure and the subjective similarity rating.

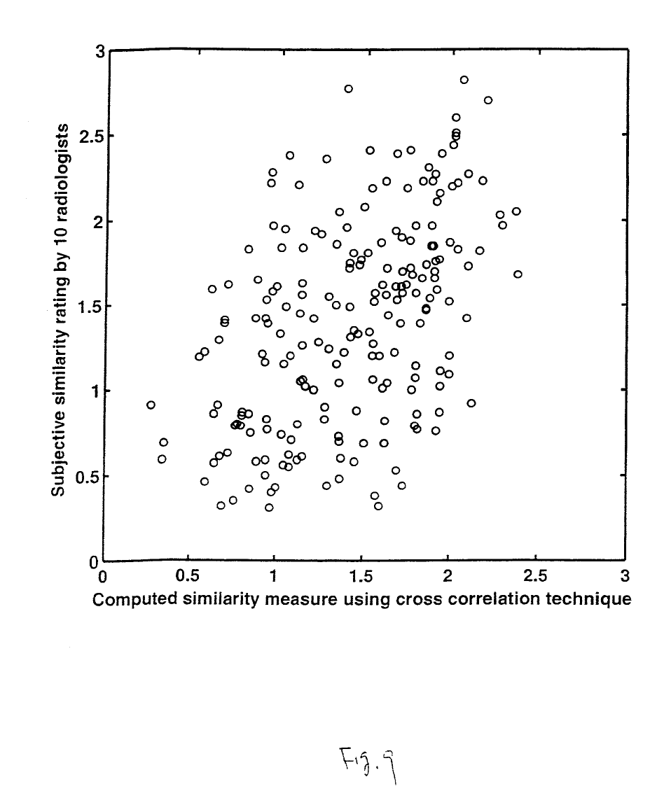

s(I,J)=3×e^{-C×}(1−c(I,J)) (11)

where s(I,J) is the similarity measure, c(I,J) is the cross correlation coefficient, and C is a coefficient. In this study, C was determined to be 5.47 by use of the least square method. (See Reference 16). FIG. 9 shows the distribution of the similarity measure based on the cross-correlation coefficient against the subjective similarity ratings assessed by ten radiologists. The correlation coefficient between the correlation-based similarity measure and the subjective similarity ratings was 0.45, which indicates that this similarity measure is inferior to the feature-based and the pixel-value-difference based measures. The low correlation values obtained with the cross-correlation technique and the pixel-value-difference based technique may be related to the fact that these techniques depend on the overall shape information of abnormalities, and do not include some specific information such as the contrast. As described above, however, the shape information alone, such as degree of circularity and degree of irregularity, does not appear to be critical in the determination of subjective similarity ratings by observers.

Artificial Neural Network Determination of Similarity Measure

The subjective similarity ratings were then used to design an artificial neural network (ANN) for the determination of a similarity measure. A three-layer ANN was designed, with an input layer, an output layer, and a hidden layer. (See References 14, 18, and 19). The input units represented various features determined from a pair of two abnormalities to be compared, and the single output unit represented the similarity measure for the pair of abnormalities. In the process of training for the ANN, the subjective similarity ratings were employed as the teaching signal, i.e., the output of the ANN. It should be noted, therefore, that the ANN was trained to learn the relationship between the various features of two abnormalities and the corresponding subjective similarity ratings by radiologists. Thus, it is expected that the similarity measure, a unique new measure, determined by the ANN would correlate well with the subjective similarity ratings. In this study, a round-robin (leave one out) method was used for verifying the effectiveness of the ANN. With this method, one pair of abnormalities was excluded from the total of 240 pairs of abnormalities, and the remaining 239 pairs were used for training of the ANN. After the ANN was trained, the features of the pair of abnormalities excluded for training were entered as inputs to the ANN for determination of a new similarity measure as output of the ANN. This process was repeated for each of the 240 pairs of abnormalities one by one, until all similarity measures for the 240 pairs of abnormalities were calculated.

Various combinations of features for inputs were tested for the determination of similarity measures by use of ANNs. Table 3 shows the performance of five ANNs with different combinations of features which were used as inputs to the ANN for the determination of similarity measures. The performance was evaluated in terms of the correlation coefficient between the ANN output and the subjective similarity ratings. It should be noted that the three features (effective diameter, CT value, and RGI) used in the ANNs were first selected based on their correlation with the subjective similarity ratings, as shown in FIG. 7. For the first three ANNs in Table 3, the inputs of the ANNs included (a) six features (three from each of the two abnormalities to be compared), (b) three differences in features between the two abnormalities, and (c) the combination of the six features and the three differences. The ANN using the differences of the three features alone provided a low correlation coefficient (0.60) compared to that (0.68) using the six feature determined from the two abnormalities, which is understandable because the three differences did not provide all the information included in the six feature values. However, the correlation coefficient (0.64) obtained with the ANN using the combination of the six features and the three differences was also lower than that obtained using the six features.

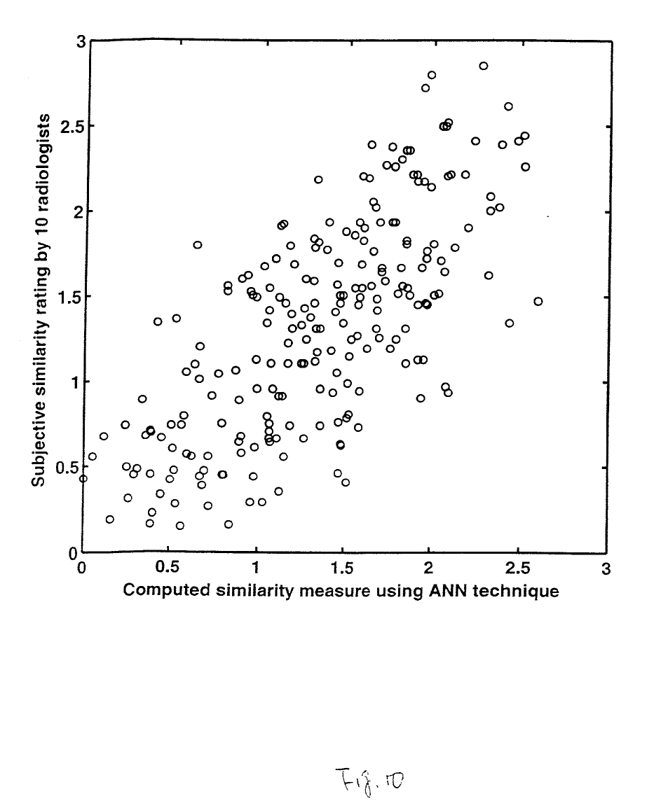

The combination of the six features with (d) the cross-correlation value or (e) the pixel-value-difference was also examined. The ANN obtained with the combination of the six features and the pixel-value-difference provided a relatively large correlation coefficient (0.72) between the output of the ANN and the subjective similarity rating. However, the inclusion of the cross-correlation value did not improve the correlation coefficient (0.64). Because the mean correlation coefficient between the similarity ratings by a single radiologist and the average similarity ratings by the other nine radiologists was only 0.62, the similarity measures determined by use of the ANN are comparable to those obtained by a single radiologist. FIG. 10 illustrates the distribution of the similarity measures obtained with the ANN against the subjective similarity ratings by ten radiologists. It is apparent from FIG. 10 that this ANN-based method provided a good similarity measure compared to the other methods examined in this study, which would thus be useful for the determination of similar images to an unknown new abnormality.

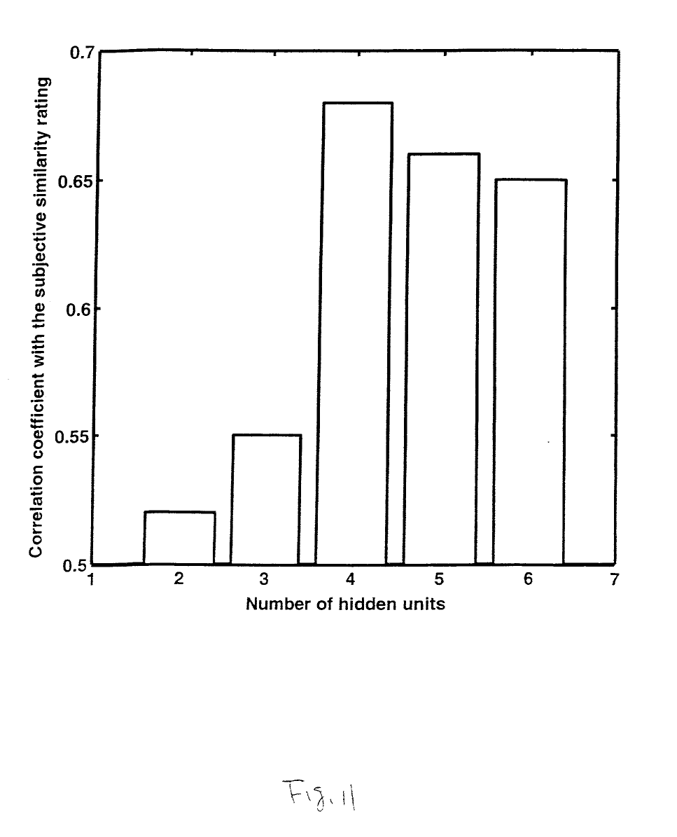

An important parameter concerning the use of ANNs is the determination of the number of hidden units. In all of the ANNs described above, the number of hidden units was set to be approximately half of the number of input and output units, which has been commonly employed in ANNs applied to computer-aided schemes for detection and classification of abnormalities on chest radiographs or masses on mammograms. (See References 14, 18, and 19). In order to examine the effect of the number of hidden units on the performance of an ANN, the number of hidden units was varied as illustrated in FIG. 11. The six features determined from the two abnormalities were used as inputs to the ANNs. FIG. 11 shows the relationship between the performance of the ANNs and the number of hidden units used. The largest correlation coefficient was obtained when the number of hidden units was 4, which was approximately half the number of input (6) and output (1) units. Similar results were observed for ANNs with different numbers of input units. Therefore the number of hidden units was selected to be approximately half the total number of input and output units.

The relationship between the subjective similarity ratings and the features determined from a pair of abnormalities appears very complex and highly non-linear; therefore, simple analytic equations such as those discussed above would not be sufficiently useful to express this type of relationship. For ANNs commonly used in the CAD schemes for the classification of lung abnormalities, (see References 14 and 18) the output of the ANNs indicated the likelihood of malignancy for an abnormality, which had little relevance to the similarity measure between a pair of abnormalities. Therefore an ANN that achieved a good performance in the distinction between malignant and benign abnormalities usually could not provide a good similarity measure between a pair of abnormalities. In this study, the subjective similarity ratings by radiologists were purposely used to train the ANN so that it could learn the relationship between the subjective similarity ratings and the features of two abnormalities. The ANN trained in this way is expected to provide a similarity measure that would correlate well with the subjective similarity ratings by radiologists. Therefore, this ANN technique may be employed to obtain similar images of malignant and benign abnormalities to an unknown new abnormalities.

In summary, the computer-aided scheme for distinguishing between benign and malignant abnormalities in medical images can be implemented based on the similarity measures defined above. First, a database of medical images with a number (e.g., three (3)) of malignant and benign abnormalities is created, from which many pairs of similar images for malignant and benign abnormalities are selected. The subjective ratings for the similarities of the pairs are determined and the ANN is trained by use of the subjective ratings and a number of features derived from the pairs of images to provide a similarity measure as the output of the ANN.

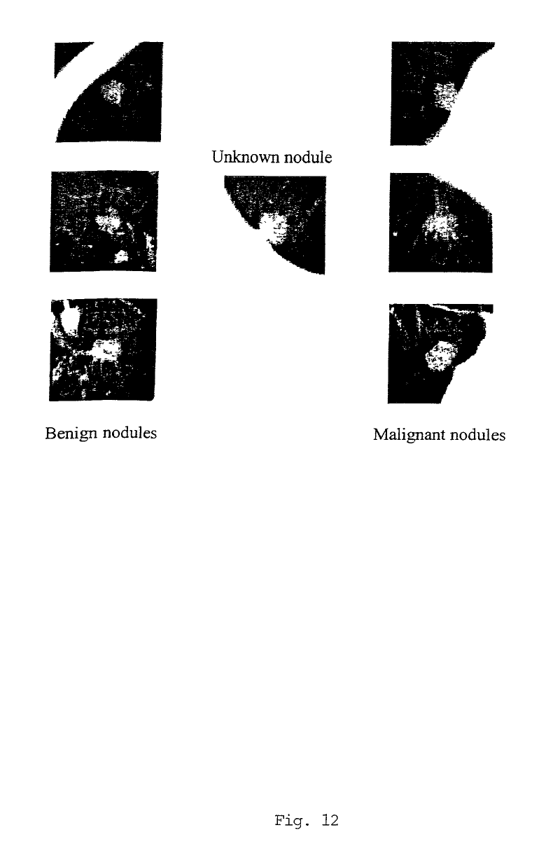

For a new unknown abnormality to be diagnosed, the trained ANN is employed for the determination of a number of images (such as three benign and three malignant cases) which would be subjectively similar to the new case, by entering a number of features as input for all combinations of the new case with every case in the database. Those cases in the database which provide the largest output values of the ANN, namely, the largest similarity measures, are then selected as similar cases which would be used as the aid to radiologists' diagnosis. FIG. 12 shows an example for the diagnosis of an unknown abnormality with the aid of similar images of three benign abnormalities and three malignant abnormalities.

Computer and System

This invention conveniently may be implemented using a conventional general purpose computer or micro-processor programmed according to the teachings of the present invention, as will be apparent to those skilled in the computer art. Appropriate software can readily be prepared by programmers of ordinary skill based on the teachings of the present disclosure, as will be apparent to those skilled in the software art.

As disclosed in cross-referenced U.S. patent application Ser. No. 09/818,831, a computer implements the method of the present invention, wherein the computer housing houses a motherboard which contains a CPU, memory (e.g., DRAM, ROM, EPROM, EEPROM, SRAM, SDRAM, and Flash RAM), and other optical special purpose logic devices (e.g., ASICS) or configurable logic devices (e.g., GAL and reprogrammable FPGA). The computer also includes plural input devices, (e.g., keyboard and mouse), and a display card for controlling a monitor. Additionally, the computer may include a floppy disk drive; other removable media devices (e.g. compact disc, tape, and removable magneto-optical media); and a hard disk or other fixed high density media drives, connected using an appropriate device bus (e.g., a SCSI bus, an Enhanced IDE bus, or an Ultra DMA bus). The computer may also include a compact disc reader, a compact disc reader/writer unit, or a compact disc jukebox, which may be connected to the same device bus or to another device bus.

As stated above, the system includes at least one computer readable medium. Examples of computer readable media are compact discs, hard disks, floppy disks, tape, magneto-optical disks, PROMs (e.g., EPROM, EEPROM, Flash EPROM), DRAM, SRAM, SDRAM, etc. Stored on any one or on a combination of computer readable media, the present invention includes software for controlling both the hardware of the computer and for enabling the computer to interact with a human user. Such software may include, but is not limited to, device drivers, operating systems and user applications, such as development tools. Such computer readable media further includes the computer program product of the present invention for performing the inventive method herein disclosed. The computer code devices of the present invention can be any interpreted or executable code mechanism, including but not limited to, scripts, interpreters, dynamic link libraries, Java classes, and complete executable programs. Moreover, parts of the processing of the present invention may be distributed for better performance, reliability, and/or cost. For example, an outline or image may be selected on a first computer and sent to a second computer for remote diagnosis.

The invention may also be implemented by the preparation of application specific integrated circuits or by interconnecting an appropriate network of conventional component circuits, as will be readily apparent to those skilled in the art.

Numerous modifications and variations of the present invention are possible in light of the above teachings. It is therefore to be understood that within the scope of the appended claims, the invention may be practiced otherwise than as specifically described herein.

TABLE 1
Features Employed for the Determination of Similarity Measures

| Feature | Definition | Significance |
|---|---|---|
| Effective Diameter | Diameter of an “equivalent” | Malignant nodules have a |
| | circle with the same area as | larger diameter value |
| | that of a nodule | |
| Degree of Circularity | Ratio of the overlap area of | Malignant nodules have |
| | the nodule and the | smaller circularity value |
| | equivalent circle to the total | |
| | area of the nodule | |
| Degree of Irregularity | One minus the ratio of the | Malignant nodules have |
| | perimeter of the equivalent | larger irregularity value |
| | circle to that of the nodule | |
| CT Value | Average CT value over a | Malignant nodules have |
| | 7 × 7 region at the center of | smaller CT value |
| | the nodule | |
| Contrast | Difference of average CT | Malignant nodules have a |
| | value over the above 7 × 7 | smaller contrast value |
| | region and that over the | |
| | ring-shaped background | |
| | region | |
| Pixel Standard Deviation | Standard deviation of the | Malignant nodules have a |
| | pixel values inside the | larger value |
| | nodule | |
| Radial Gradient Index (RGI) | Ratio of average magnitude | Malignant nodules have |
| | value of edge gradient | smaller RGI value |
| | projected to the radial | |
| | direction to that of edge | |
| | gradient without projection | |

TABLE 2
Correlation Coefficients Between the Subjective Similarity Ratings
Assessed by Ten Radiologists and the Computed Similarity Measures by
Use of Each of the Seven Features

| | Correlation Coefficient Between |
|---|---|
| Feature Used for Determination of | Subjective Similarity and Computed |
| Similarity Measures | Similarity |
| Effective Diameter | −0.47 |
| Degree of Circularity | −0.23 |
| Degree of Irregularity | 0.02 |
| CT Value | −0.40 |
| Contrast | −0.39 |
| Standard Deviation | −0.31 |
| Radial Gradient Index (RGI) | −0.33 |

TABLE 3
Performance of ANNs with Various Combinations of Features for the
Determination of Similarity Measures

| | Correlation Coefficient with |
|---|---|
| Inputs to ANN for Determination of | Subjective Similarity Rating |
| Similarity Measure | by Ten Radiologists |
| (a) Six inputs (diameter, CT value, | 0.68 |
| and RGI for two nodules) | |
| (b) Three inputs (difference in | 0.60 |
| diameter, CT value, and RGI between | |
| two nodules) | |
| (c) Nine inputs (diameter, CT value and | 0.64 |
| RGI for two nodules and their difference) | |
| (d) Seven inputs (diameter, CT value and | 0.64 |
| RGI value for two nodules, and cross | |
| correlation) | |
| (e) Seven inputs (diameter, CT value and | 0.72 |
| RGI for two nodules, and pixel difference) | |

What is claimed as new and desired to be secured by Letters Patent of the United States is:

1. A method of evaluating a candidate abnormality in a medical image, comprising the steps of:
obtaining a medical image having a candidate abnormality;
segmenting the candidate abnormality in the medical image;
extracting at least one predetermined feature from the segmented candidate abnormality;
comparing the candidate abnormality with plural database abnormalities including known malignant abnormalities and known benign abnormalities, including comparing the at least one extracted feature from the at least one candidate abnormality with corresponding extracted features extracted from the database abnormalities;
identifying, based on the comparing step, at least one database malignant abnormality and at least one database benign abnormality having similarity to the candidate abnormality; and
displaying the database abnormalities identified in the identifying step.

2. The method of claim 1, wherein the extracting step comprises:
extracting at least one feature from the group comprising effective diameter, degree of circularity, contrast, degree of irregularity, pixel standard deviation, radial gradient index (RGI), and computed tomography (CT) value.

3. The method of claim 1, wherein the extracting step comprises:
extracting at least two features from the group comprising effective diameter, degree of circularity, contrast, degree of irregularity, pixel standard deviation, radial gradient index (RGI), and computed tomography (CT) value.

4. The method of claim 3, wherein said at least two features comprise effective diameter and CT value.

5. The method of claim 1, wherein the extracting step comprises:
extracting at least three features from the group comprising effective diameter, degree of circularity, contrast, degree of irregularity, pixel standard deviation, radial gradient index (RGI), and computed tomography (CT) value.

6. The method of claim 5, wherein said at least three features comprise effective diameter, CT value, and RGI.

7. The method of claim 1, wherein the comparing step further comprises:
calculating at least one similarity measure based on an absolute difference between at least one extracted feature of the candidate abnormality and at least one corresponding feature of a database abnormality.

8. The method of claim 1, wherein the step of segmenting a candidate abnormality in a medical image further comprises:
obtaining a CT medical image.

9. The method of claim 1, wherein the segmenting step further comprises:
using a region growing technique.

10. The method of claim 9, wherein the segmenting step further comprises:
region growing from a point included in a manually generated outline.

11. The method of claim 1, wherein the comparing step comprises:
using an artificial neural network (ANN); and
determining a similarity measure based on an output of the ANN.

12. The method of claim 11, wherein the using step comprises:
using an ANN having at least three levels.

13. The method of claim 11, wherein the determining a similarity measure further comprises:
identifying at least one similar malignant database abnormality and at least one benign abnormality based on an output of the ANN; and
displaying the database abnormalities identified in the identifying step.

14. The method of claim 13, wherein the displaying step comprises displaying at least one candidate abnormality with at least one malignant abnormality and at least one benign abnormality on a common display.

15. The method of claim 11, wherein the using step further comprises:
training the ANN based on at least one subjective similarity rating.

16. The method of claim 11, wherein the using step comprises:
using an ANN trained at least in part by means of at least one subjective similarity rating.

17. The method of claim 1, wherein the displaying step comprises displaying at least one candidate abnormality with at least one malignant abnormality and at least one benign abnormality on a common display.

18. A system implementing the method of any one of claims 1 through 17.

19. A computer program product storing program instructions for execution on a computer system, which when executed by the computer system, cause the computer system to perform the method recited in any one of claims 1 through 17.
